(19) United States
(12) Patent Application Publication
(10) Pub. No.: US 2010/0239457 A1
(43) Pub. Date: Sep. 23, 2010

(54) BIOCHIP

(75) Inventors: Byoung-Su Lee, Yeosu-si (KR); Do-Young Lee, Seongnam-si (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SILICONFILE TECHNOLOGIES INC., Seoul (KR)

(21) Appl. No.: 12/599,979

(22) PCT Filed: Oct. 15, 2007
(86) PCT No.: PCT/KR2007/005035

§ 371 Date: Nov. 13, 2009

(30) Foreign Application Priority Data
May 16, 2007 (KR) 10-2007-0047583

(51) Int. Cl. G01N 21/27

(52) U.S. Cl. 422/55

(57) ABSTRACT

Provided is a biochip including a high-sensitivity image sensor. The biochip includes: a biochip layer including a plurality of reaction zones in which biochemical reactions occur formed as concaves, the reaction zone including a reference material at a lower portion and a target material at an upper portion; and an image sensor layer which is formed below the biochip layer and includes a plurality of photo detectors. Since the biochip is implemented as a single chip including the biochip layer and the image sensor layer, light loss in the luminescence or fluorescence operation can be reduced. In addition, additional devices such as a scanner which are needed for a general biochip are not needed, so that sensitivity is improved, and low-cost biochips can be implemented.

### TECHNICAL FIELD

The present invention relates to a biochip, and more particularly, to a biochip including a high-sensitivity image sensor.

### BACKGROUND ART

In general, a biochip is formed by arraying reference materials including biological molecules such as DNA and proteins on a substrate made of a material such as glass, silicon, or nylon. The biochips are classified into DNA chips and protein chips and the like according to a type of the arrayed reference materials. The biochip basically uses biochemical reactions between the reference material fixed to the substrate and a target material. Representative examples of the biochemical reactions between the reference material and the target material include a complementary binding of DNA bases and an antigen-antibody reaction.

Diagnoses using the biochip are performed by detecting a degree of biochemical reactions through an optical process. A general optical process uses fluorescence or luminescence.

In an example of the optical process using fluorescence, the target material injected into the reference material fixed to the biochip is combined with a fluorescent material, and the fluorescent material remains when a specific biochemical reaction between the reference material and the target material occurs. Thereafter, the remained fluorescent material emits light through an external light source, and the emitted light is measured.

In an example of the optical process using luminescence, the target material injected into the reference material fixed to the biochip is combined with a luminescent material, and the luminescent material remains when a specific biochemical reaction between the reference material and the target material occurs. Thereafter, the remained luminescent material emits light without an external light source, and the emitted light is measured.

FIG. 1 illustrates a structure of a conventional biochip.

Referring to FIG. 1, the conventional biochip 100 includes various types of reference materials 120 which are arrayed at predetermined intervals on a substrate 110 made of a material such as glass.

When a target material is injected into the reference material 120 of the conventional biochip 100, a biochemical reaction between the target material and the reference material 120 occurs. Here, when a certain amount of the fluorescent material or the luminescent material is included in the target material by a chemical bond, an amount of the fluorescent material or the luminescent material that remains after the biochemical reactions occurs is changed according to the degree of the biochemical reactions.

When the biochip 100 in which the biochemical reactions between the reference material and the target material occur is irradiated, the fluorescent material emits specific light. In order to increase intensity of the light emitted from the fluorescent material, an intense laser is generally used for the irradiation. The light emitted from the fluorescent material is represented as an image by an apparatus for obtaining the image.

FIG. 2 is a flowchart of an example of operations 200 of the conventional biochip.

When the target material combined with the fluorescent material or the luminescent material is injected into the reference material fixed to the biochip, biochemical reactions between the reference material and the target material occur (operation S210). After the biochemical reactions between the reference material and the target material occur and the fluorescent material is irradiated, the fluorescent material emits specific light. When the luminescent material is included in the target material, external light is blocked, and the luminescent material emits specific light.

Next, an image of the light emitted from the fluorescent material or the luminescent material is obtained by using an additional scanning apparatus (operation S220). The obtained image is read by a person with medical knowledge (operation S230).

FIG. 3 illustrates an example of the apparatus for obtaining an image generated from the conventional biochip 100. Conventionally, a charge-coupled device (CCD) image sensor 310 and devices such as a laser scanner, a microscope, and the like described in Korea Patent Application No. 10-2005-0050858 (published on Jun. 1,2005) are used.

Generally, intensity of light generated from the fluorescent material by irradiation 301 is low. Therefore, when the general CCD image sensor 310 is used to detect the light generated from the fluorescent material, since the CCD image sensor 310 using a semiconductor is vulnerable to thermal noise, the CCD image sensor 310 needs a long exposure time in order to collect light. Since the thermal noise increases in proportion to the exposure time, a large amount of noise is included in the detected light, and this causes a decrease in a light detection efficiency. Therefore, conventionally, an additional treatment is performed on the CCD image sensor 310 in order to increase the light detection efficiency.

A representative example of the additional treatment is to cool the CCD image sensor 310. The cooling of the CCD image sensor 310 decreases generation of thermoelectrons and reduce the thermal noise generated by the thermoelectrons, so that there is an advantage of increasing the light detection efficiency. However, the cooling of the CCD image sensor 310 has a problem in that complex operations for the cooling and an additional apparatus are needed.

In addition, the CCD image sensor 310, the laser scanner, and the microscope are expensive, and this is an obstacle to commercialize the biochips.

### DETAILED DESCRIPTION OF THE INVENTION

### Technical Goal of the Invention

The present invention provides a biochip which has a high-sensitivity image sensor and is implemented in a single chip, so that additional devices such as a high-cost scanning device is not needed, and an image signal processor in the image sensor processes a image signals, analyzes results of biochemical reactions of the biochip in a chip level, and can output final determination.

### DISCLOSURE OF THE INVENTION

According to an aspect of the present invention, there is provided a biochip including: a biochip layer including a plurality of reaction zones in which biochemical reactions occur formed as concaves, the reaction zone including a reference material at a lower portion and a target material at an upper portion; and an image sensor layer which is formed below the biochip layer and includes a plurality of photo detectors.

According to another aspect of the present invention, there is provided a biochip including: a biochip layer including a plurality of reaction zones in which biochemical reactions occur formed as concaves, the reaction zone including a reference material at a lower portion and a target material at an upper portion; and an image sensor layer which is formed below the biochip layer and includes a plurality of photo detectors, wherein a band pass filter or a low pass filter is formed on a plurality of the photo detectors.

### BRIEF DESCRIPTION OF THE DRAWINGS

FIG. 1 illustrates a conventional biochip.

FIG. 2 is a flowchart of operations of the conventional biochip.

FIG. 3 illustrates an apparatus for scanning the biochip illustrated in FIG. 1.

FIG. 4 illustrates a cross sectional view of a biochip according to an embodiment of the present invention.

FIG. 5 is a top plan view of the biochip illustrated in FIG. 4.

FIG. 6 illustrates a biochip according to another embodiment of the present invention.

FIGS. 7 and 8 illustrate examples of a dark level and a white level of the biochips illustrated in FIGS. 4 and 6.

FIG. 9 illustrates an example of a degree of reactions in cases of the dark level and the white level.

FIG. 10 is a flowchart of an example of operations of a biochip according to the present invention.

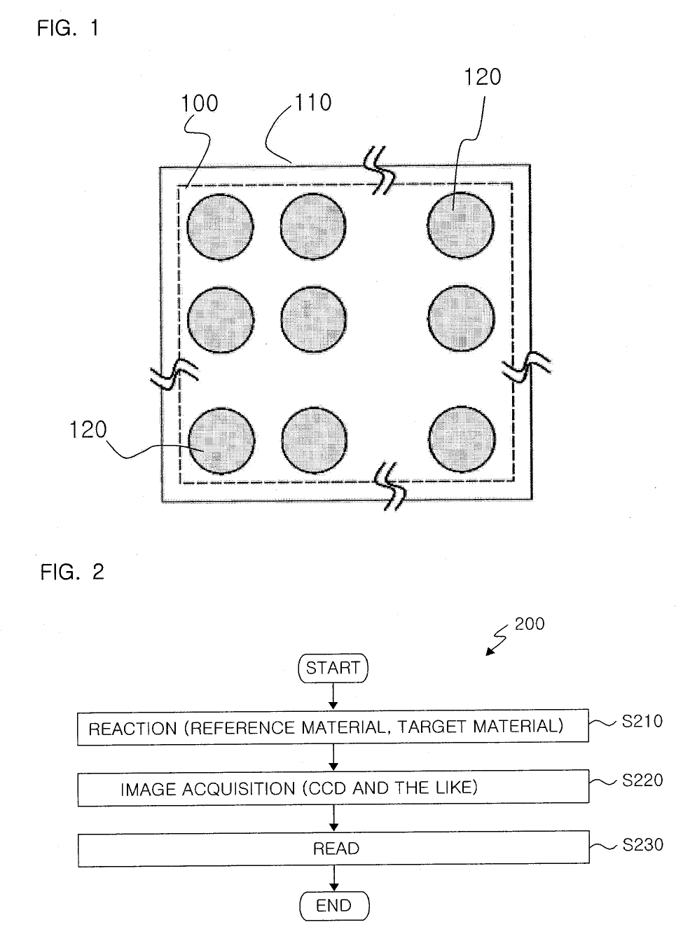

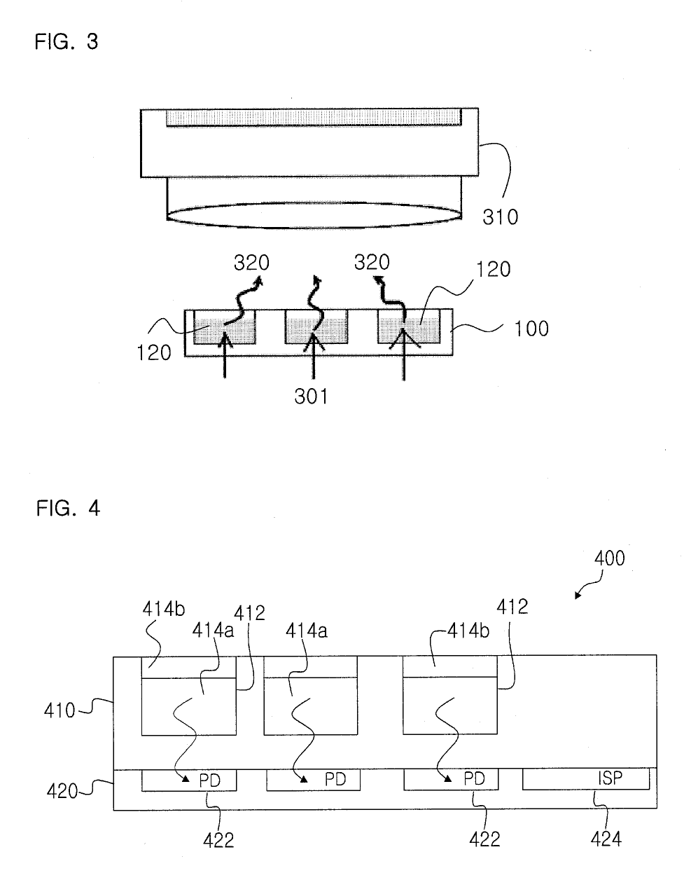

### BEST MODE FOR CARRYING OUT THE INVENTION

Hereinafter, exemplary embodiments of the present invention will be described in detail with reference to the attached drawings.

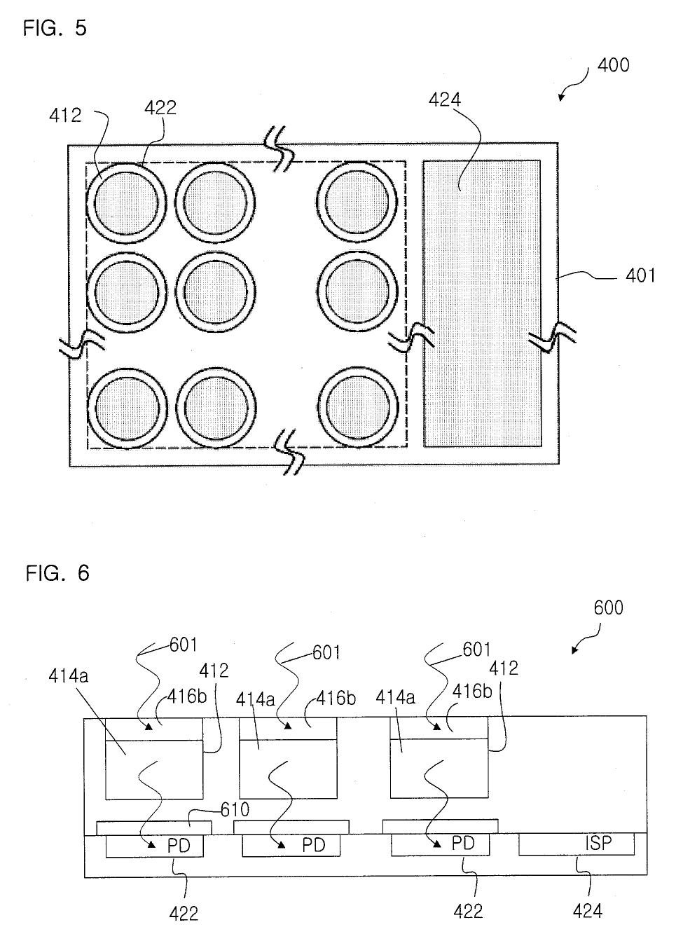

FIG. 4 illustrates a cross sectional view of a biochip according to an embodiment of the present invention. FIG. 5 is a top plan view of the biochip 400 illustrated in FIG. 4.

The biochip 400 illustrated in FIG. 4 is implemented on a single substrate 401 including a biochip layer 410 and an image sensor layer 420.

In the biochip layer 410, a plurality of reaction zones 412 are formed as concaves. A reference material 414a is included in a lower portion of the reaction zone 412, and a target material 414b is inserted into an upper portion of the reaction zone 412. The target material 414b may include a luminescent material which emits light when external light is blocked. For example, the luminescent material is luciferin. When the luciferin is activated by adenosine tri-phosphate (ATP), the activated luciferin is oxidized by operations of luciferase, and in the meanwhile, chemical energy is converted into optical energy and light is produced.

Here, the concave shape of the reaction zone 412 can be easily formed by an etching process in a semiconductor manufacturing process.

A type of the reference material 414a is changed according to a desired biochemical reaction. When the biochemical reaction is an antigen-antibody reaction, the reference material 414a may be an antigen. When the biochemical reaction is a complementary binding of DNA bases, the reference material 414a may be a gene manipulated to perform the complementary binding. A type of the target material 414b which reacts with the reference material 414a is determined according to the type of reference material 414a. For example, when the reference material 414a is the antigen, the target material 414b may be blood or the like. When the reference material 414a is the manipulated gene, the target material 414b may be a gene of a user.

The image sensor layer 420 is formed below the biochip layer 410 and includes a plurality of photo detectors 422. Below each of a plurality of the reaction zones 412 of the biochip 410, a single or a number of photo detectors 422 of the image sensor layer 420 may be formed.

When a degree of biochemical reactions between the reference material 414a and the target material 414b such as the complementary binding of DNA bases and the antigen-antibody reaction varies according to the reaction zones 412, a remaining amount of luminescent material such as luciferin combined with the target material 414b may vary according to the reaction zones 412. Here, when external light is blocked so that the remaining luminescent material emits light, intensity of light emitted from the luminescent materials of the reaction zones 412 varies according to the remaining amounts of the luminescent materials. Therefore, intensity of light from each of the reaction zones 412 detected by the photo detectors 422 varies according to the photo detectors 422.

The light detected by the photo detector 422 is output as an electric signal, and the electric signal is processed by a signal processing unit such as an image signal process (ISP). Here, as illustrated in FIGS. 4 and 5, the image sensor layer 420 may includes a signal processing unit 424.

According to the present invention, the biochip layer 410 and the image sensor layer 420 are included in a single substrate 401. Here, since the biochip uses fluorescence or luminescence due to characteristics of the biochip, the biochip layer 410 may be made of a transparent material such as glass. On the substrate 401, the image sensor layer 420 including the photo detectors 422 is firstly formed, and the biochip layer 410 including the reaction zones 412 is then formed thereon. For example, the image sensor layer 420 is easily formed on a silicon substrate by a general image sensor manufacturing process including a photo detector forming process. The biochip layer 410 may be formed by depositing a transparent material such as silicon dioxide SiO₂ on an upper portion of the image sensor layer 420 and forming a plurality of concaves for the reaction zones 412 by the etching process.

The biochip 400 illustrated in FIG. 4 has a structure in which the biochip layer 410 and the image sensor layer 420 are formed in the single substrate 401, and an interval between the reaction zone 412 of the biochip layer 410 and the photo detector 422 of the image sensor 420 can be minimized. Therefore, light loss in the light emitting process can be reduced.

FIG. 6 illustrates a biochip according to another embodiment of the present invention.

The biochip 400 illustrated in FIG. 4 uses luminescence. On the other hand, the biochip 600 illustrated in FIG. 6 uses fluorescence. In order to use fluorescence, a fluorescent material which is irradiated to produce light at a predetermined wavelength is required. The fluorescent material may be produced in the reaction zones 412 as a result of the reactions between the reference material 414a and the target material 414b. In addition, an arbitrary fluorescent material such as green fluorescence protein (GFP) is combined with the target material 414b, so that the fluorescent material remains in the reaction zones 412 after specific biochemical reactions between the reference material 414a and the target material 414b occur.

Here, when the remaining florescent material is irradiated, a remaining amount of the fluorescent material varies according to a degree of the biochemical reactions between the reference material 414a and the target material 414b, and the fluorescent material emits light of different intensity. The biochip using fluorescence may use UV light or blue light in order to obtain effective fluorescence by the irradiation 601. The fluorescent material may be a material that can emit light having a specific band.

Therefore, in order to block light used as the irradiation 601 and measure only light produced from the fluorescent material remaining after the biochemical reactions between the reference material 414a and the target material 414b, the biochip 600 illustrated in FIG. 6 includes filter units 610 formed at upper portions of a plurality of photo detectors. The filter unit 610 may be a band pass filter (BPF) or a low pass filter. In order to pass light at a predetermined band, the BPF may be preferably used. The BPF may use an optical filter or a photoresist. In the latter case, the BPF can be manufactured by adding a pigment to the photoresist in the general semiconductor manufacturing process.

When the BPF is used as the filter unit 610, the light used for the irradiation 601 is blocked by the BPF, and light only at the predetermined band passes through the filter unit 610 and arrives at a plurality of the photo detectors 422. Here, the filter unit 610 may be formed on a plurality of the photo detectors 422 as a single layer or formed on each of the photo detectors 422.

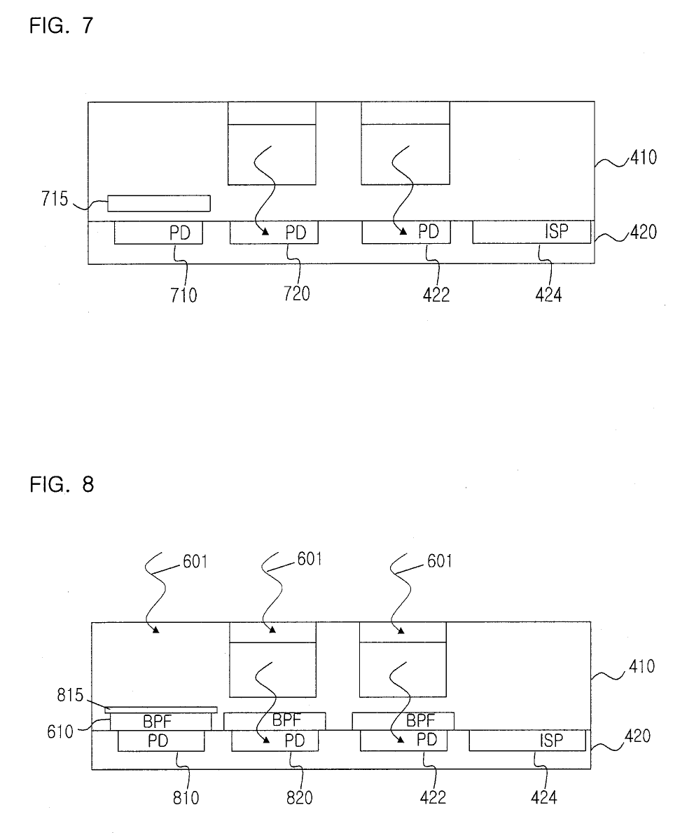

In order to practically use the biochips 400 and 600 illustrated in FIGS. 4 and 6, as illustrated in FIGS. 7 and 8, an electric signal (dark level) output from the photo detectors 710 and 810 corresponding to a case where it is assumed that the biochemical reactions between the reference material 414a and the target material 414b do not occur (the degree of the biochemical reactions is 0%), and an electric signal (white level) output from the photo detectors 720 and 820 corresponding to a case where it is assumed that the biochemical reactions between the reference material 414a and the target material 414b occur completely (the degree of the biochemical reactions is 100%) are set so as to be used as a reference signal. Here, light blocking films 715 and 815 may be formed on the photo detectors 710 and 810 which output signals corresponding to the case where the biochemical reactions do not occur in the reaction zones 412. Although the biochemical reactions occur in the reaction zones 412 disposed on the light blocking films 715 and 815 and light by fluorescence or luminescence is emitted, the light is blocked by the light blocking films 715 and 815, so that the reaction zones 412 may not be provided to upper portions of the light blocking films 715 and 815.

When an absolute value of the electric signal output from the photo detectors 710 and 810 corresponding to the dark level and an absolute value of the electric signal output from the photo detectors 720 and 820 corresponding to the white level are obtained, the degree of the biochemical reactions between the reference material 414a and the target material 414b can also be obtained according to the absolute values of the electric signals output from the photo detectors.

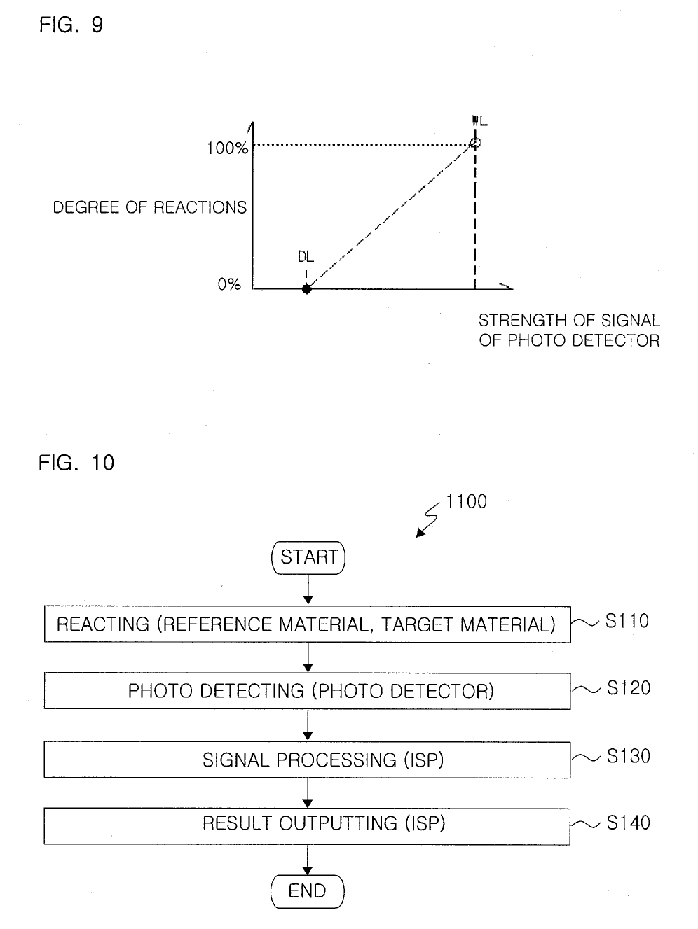

FIG. 9 illustrates an example of the degree of the biochemical reactions between the reference material 414a and the target material 414b in the case where it is assumed that the degree of the biochemical reactions between the reference material 414a and the target material 414b is 0% (referred to as dark level, DL) and in the case where it is assumed that the degree of the biochemical reactions is 100% (referred to as white level, WL). Referring to FIG. 9, the degree of the biochemical reactions between the reference material 414a and the target material 414b can be obtained from strength of the electric signals output from the photo detector 422.

FIG. 10 is a flowchart of an example of operations of the biochip according to the present invention.

Referring to FIG. 10, the operations 1100 of the biochip 400 or 600 illustrated in FIG. 4 or 6 include a reacting operation (S110), a photo detecting operation (S120), a signal processing operation (S130), and an outputting operation (S140). In the reacting operation (S110), biochemical reactions between the reference material 414a and the target material 414b occur at a plurality of the reaction zones 412 of the biochip layer 410. If the biochemical reaction is the antigen-antibody reaction, the reference material 414a may be the antigen, and the target material 414b may be blood of a person. The target material 414b may be combined with the luminescent material or the fluorescent material by chemical binding.

In the photo detecting operation (S120), light produced by fluorescence or luminescence in operations of irradiation when fluorescence is used or blocking external light when luminescence is used is detected by a plurality of the photo detectors 422 included in the image sensor layer 420 and transmitted to the signal processing unit 424 as an electric signal. Here, the signal processing unit 424 may process the electric signal generated by each of the photo detectors 422, and may process the electric signal generated by the photo detectors 422 row by row or column by column when a plurality of the photo detectors 422 are formed in an array including rows and columns.

In the signal processing operation (S130), the electric signals output from a plurality of the photo detectors 422 are transmitted to the signal processing unit 424 such as the ISP, so that intensity of light sensed by each of the photo detectors 422 is calculated by the signal processing unit 424, and the degree of the biochemical reactions between the reference material 414a and the target material 414b is calculated by the biochip layer 410.

Here, when it is assumed that the intensity of light detected by the photo detectors corresponding to the case where the degree of the biochemical reactions between the reference material 414a and the target material 414b is 0% is the dark level (DL), and the intensity of light detected by the photo detectors corresponding to the case where the degree of the biochemical reactions is 100% is the white level (WL), the intensity of light generated from each of the reaction zones 412 of the biochip layer 410 is in a range of from the DL and the WL, so that the degree of the biochemical reactions between the reference material 414a and the target material 414b can be calculated by using the intensity of the light.

In the outputting operation (S140), the degree of the biochemical reactions in each of the reaction zones 412 and medical determination results are output by the signal processing unit 424.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

As described above, in the biochip according to the present invention, an interval between the reaction zone of the biochip layer and the photo detector of the image sensor layer is minimized, so that light loss in the luminescence or fluorescence operation can be reduced. In addition, the photo detector with a large area can be used, so that sensitivity is increased.

In addition, diagnosis results of the biochip according to the present invention are processed and output by the image signal processor, so that people without medical knowledge can easily use the biochip. In addition, additional devices such as a scanner which are needed for a general biochip are not needed.

In addition, the reaction zones in which the biochemical reactions occur in the biochip according to the present invention can be easily manufactured as concaves in an image sensor manufacturing process.

1. A biochip comprising:
a biochip layer including a plurality of reaction zones in which biochemical reactions occur formed as concaves, the reaction zone including a reference material at a lower portion and a target material at an upper portion; and
an image sensor layer which is formed below the biochip layer and includes a plurality of photo detectors.

2. The biochip of claim 1, wherein the target material includes a luminescent material.

3. A biochip comprising:
a biochip layer including a plurality of reaction zones in which biochemical reactions occur formed as concaves, the reaction zone including a reference material at a lower portion and a target material at an upper portion; and
an image sensor layer which is formed below the biochip layer and includes a plurality of photo detectors,
wherein a band pass filter or a low pass filter is formed on a plurality of the photo detectors.

4. The biochip of claim 3, wherein the target material includes a fluorescent material.

5. The biochip of claim 1, wherein one or more photo detectors are formed at a lower portion of each of a plurality of the reaction zones.

6. The biochip of claim 1, wherein the image sensor layer further comprises a signal processing unit processing signals obtained from a plurality of the photo detectors.

7. The biochip of claim 1, wherein the biochip and the image sensor layer are formed in a single substrate.

8. A biochip comprising:
a biochip layer including a plurality of reaction zones in which biochemical reactions occur formed as concaves, the reaction zone including a reference material at a lower portion and a target material at an upper portion; and
an image sensor layer which is formed below the biochip layer and includes a plurality of photo detectors and a signal processing unit processing signals obtained from a plurality of the photo detectors.

9. A biochip comprising:
a biochip layer including a plurality of reaction zones in which biochemical reactions occur formed as concaves, the reaction zone including a reference material at a lower portion and a target material at an upper portion; and
an image sensor layer which is formed below the biochip layer and includes a plurality of photo detectors and a signal processing unit processing signals obtained from a plurality of the photo detectors,
wherein a band pass filter or a low pass filter is formed on each of a plurality of the photo detectors.

10. A biochip comprising:
a biochip layer including a plurality of reaction zones in which biochemical reactions occur formed as concaves, the reaction zone including a reference material at a lower portion and a target material at an upper portion; and
an image sensor layer which is formed below the biochip layer and includes a plurality of photo detectors which are parted so that a band pass filter or a low pass filter is formed on a part of the photo detectors and the band pass filter or the low pass filter is not formed on the other part of the photo detectors.

11. A biochip comprising:
a biochip layer including a plurality of reaction zones in which biochemical reactions occur formed as concaves, the reaction zone including a reference material at a lower portion and a target material at an upper portion; and
an image sensor layer which is formed below the biochip layer, includes a plurality of photo detectors which are parted so that a band pass filter or a low pass filter is formed on a part of the photo detectors and the band pass filter or the low pass filter is not formed on the other part of the photo detectors, and includes a signal processing unit processing signals obtained from a plurality of the photo detectors.

12. A biochip comprising:
a biochip layer including a plurality of reaction zones in which biochemical reactions occur formed as concaves, the reaction zone including a reference material at a lower portion and a target material at an upper portion; and
an image sensor layer which is formed below the biochip layer and includes a plurality of photo detectors,
wherein one of a plurality of the photo detectors detects light corresponding to a case where a degree of biochemical reactions in the reaction zones is 0% and outputs the detected light as an electric signal, and
wherein one of a plurality of the photo detectors detects light corresponding to a case where the degree of the biochemical reactions in the reaction zones is 100% and outputs the detected light as an electric signal.

13. The biochip of claim 12, wherein a light blocking unit is formed on the photo detector which outputs the electric signal in the case where the degree of the biochemical reactions in the reaction zones is 0%.

14. A biochip comprising:
a biochip layer including a plurality of reaction zones in which biochemical reactions occur formed as concaves, the reaction zone including a reference material at a lower portion and a target material at an upper portion; and
an image sensor layer which is formed below the biochip layer and includes a plurality of photo detectors on which a band pass filter or a low pass filter is formed,
wherein one of a plurality of the photo detectors detects light corresponding to a case where a degree of biochemical reactions in the reaction zones is 0% and outputs the detected light as an electric signal, and
wherein one of a plurality of the photo detectors detects light corresponding to a case where the degree of the biochemical reactions in the reaction zones is 100% and outputs the detected light as an electric signal.

15. The biochip of claim 7, wherein the substrate is a silicon substrate.

16. The biochip of claim 3, wherein one or more photo detectors are formed at a lower portion of each of a plurality of the reaction zones.

17. The biochip of claim 3, wherein the image sensor layer further comprises a signal processing unit processing signals obtained from a plurality of the photo detectors.

18. The biochip of claim 3, wherein the biochip and the image sensor layer are formed in a single substrate.
